(19) United States
(12) Patent Application Publication
(10) Pub. No.: US 2014/0281870 A1
(43) Pub. Date: Sep. 18, 2014

(54) DOCUMENT COLLABORATION AND NOTIFICATION OF CHANGES USING DIFFERENT NOTIFICATION MECHANISMS

(71) Applicant: MICROSOFT CORPORATION, Redmond, WA (US)

(72) Inventors: Matthew Vogel, Seattle, WA (US); Avijit Sinha, Newcastle, WA (US); Olivier Destrebecq, Seattle, WA (US); John Sanders, Seattle, WA (US); Steven Novick, Seattle, WA (US); Neha Monga, Redmond, WA (US); Shaun Bennett, Newcastle, WA (US); Darron Stepanich, Seattle, WA (US); Sunder Raman, Redmond, WA (US)

(21) Appl. No.: 13/830,079

(22) Filed: Mar. 14, 2013

(51) Int. Cl. G06F 17/24

(52) U.S. Cl. CPC G06F 17/246
USPC 715/220

(57) ABSTRACT

Users may collaborate on a document and be notified of changes (e.g. comments, changes) made to the document using different notification methods. A comment may be added to the document from within the document and/or externally from the document. A comment may also be added to a comment stream (e.g. a thread of related comments). The different notification mechanisms may include mechanisms such as: Short Message Service (SMS), Multimedia Messaging Service (MMS), electronic mail, phone call, Instant Messaging (IM), social network post/message, toast message, live tile, and the like. A user may configure the desired notification methods. A newsfeed may display a feed of collaboration items that reflect comments/changes to the document. The user may select a displayed collaboration item from the newsfeed to access the document. A user may also respond (e.g. comment) to a notification that may be added as a comment in the document.

### BACKGROUND

Collaborating on a spreadsheet can be difficult. For example, a it is difficult for users to share changes to a document. Users today email links and copies of files to show other users the latest changes. Locating and viewing the changes made by other users also be challenging.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Users may collaborate on a document, (e.g. a spreadsheet, a presentation document, a word-processing document, . . . ), and be notified of changes (e.g. comments, edits) made to the document using different notification methods. A comment may be added to the document from within the document and/or externally from the document. A comment may also be added to a comment stream (e.g. a thread of related comments). The different notification mechanisms may include mechanisms such as: Short Message Service (SMS), Multimedia Messaging Service (MMS), electronic mail, Instant Messaging (IM), social network post/message, Mobile Phone Notification Queue, toast mechanism, live tile mechanism and the like. A user may configure the desired notification methods. A newsfeed may display a feed of collaboration items that reflect comments/changes to the document. The user may select a displayed collaboration item from the newsfeed. If not already opened, the selection of the link may automatically open the application associated with the document (e.g. a spreadsheet application) and automatically navigate to the relevant portion of the document that was changed. A user may also respond (e.g. comment) to a notification. For example, a response to a received notification may add the response to a comment stream within the document.

### BRIEF DESCRIPTION OF THE DRAWINGS

FIG. 1 shows a system for collaborating on a document;

FIG. 2A shows exemplary notification mechanisms used during collaboration on a document;

FIG. 2B shows exemplary documents that may be collaborated on;

FIG. 3 shows exemplary notification mechanisms used during collaboration on a document;

FIG. 4 shows exemplary notifications created in response to a user selecting a portion of a document and making a comment during collaboration on a document;

FIG. 5 shows exemplary notifications created in response to a user selecting a portion of a document and making a comment during collaboration on a document;

FIG. 6 shows an illustrative process for notifying users of changes made to a document during collaboration;

FIG. 7 illustrates an exemplary system for collaborating on a document using different notification mechanisms; and

FIGS. 8, 9A, 9B, and 10 and the associated descriptions provide a discussion of a variety of operating environments in which embodiments of the invention may be practiced.

### DETAILED DESCRIPTION

Referring now to the drawings, in which like numerals represent like elements, various embodiment will be described.

FIG. 1 shows a system for collaborating on a document. As illustrated, system 100 includes application program 110, collaboration manager 26 touch screen input display 115 and notification mechanisms 130.

In order to facilitate communication with the collaboration manager 26, one or more callback routines, may be implemented. According to an embodiment, application program 110 is a business productivity application, such as a spreadsheet application, a word-processing application, a presentation application, and the like that is configured to receive input from a touch-sensitive input display 115 and/or keyboard input (e.g. a physical keyboard and/or SIP) and/or other types of input (e.g. speech and/or some other input sensing). For example, collaboration manager 26 may provide information to application 110 in response to a user's input.

System 100 as illustrated comprises a touch screen input display 115 that detects when a touch input has been received (e.g. a finger touching or nearly touching the touch screen). For example, a user may tap to select a user interface element, perform a stretch gesture to zoom in, and the like. Gestures may include, but are not limited to: a pinch gesture; a stretch gesture; a select gesture (e.g. a tap action on a displayed element); a select and hold gesture (e.g. a tap and hold gesture received on a displayed element); a swiping action and/or dragging action and/or double tap; and the like. Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

Collaboration manager 26 is configured to performs operations relating to collaboration on a document. Users may collaborate on a document, such as spreadsheet 118, and be notified of changes (e.g. comments, content changes, object changes) made to the document using different notification methods. While examples presented herein show collaboration on a spreadsheet document, other documents may be collaborated on (e.g. word-processing documents, presentation documents, as well as other documents). According to an embodiment, collaboration may occur on more than one type of document. For example, a project may include different collaborators that are working on different types of documents. When a change is made to one of the associated documents in the project, the different collaborators may be notified as discussed herein. A comment, such as comment 120, may be added to the document from within the document and/or externally from the document (e.g. reply to a notification message). In the current example, a user (Matthew) has created comment 120 and has selected content 122 that relates to the comment. Different content may be selected (e.g. a cell, a word, a paragraph, a chart, a picture, a range of cells/content and the like) by the user that is associated with a comment. According to an embodiment, content relating to the comment is automatically selected based on where a user enters the comment within the document (e.g. select a chart when the comment is made near the chart, select a cell when the comment is made on the cell, and the like). A comment may also be added to a comment stream 120′ (e.g. a thread of related comments). Comment stream 120′ illustrates two related comments in a comment stream within spreadsheet 118. A comment may be added to a comment stream while working with the document and/or from an external mechanism. In the current example, Olivier has replied 134 to an SMS notification 132 of the comment made by Matthew. After responding to a notification, the response may be automatically associated with the previous comment/changed content.

Different notification mechanisms 130 may be used to notify the different collaborators of changes/comments that are made to the document (e.g. spreadsheet 118). The different notification mechanisms may include mechanisms such as: Short Message Service (SMS) 132, Multimedia Messaging Service (MMS), electronic mail, phone call, Instant Messaging (IM), social network post/message, newsfeed 134, a Mobile Phone Notification Queue (not shown) and the like. A user may configure the desired notification methods.

A newsfeed (e.g. newsfeed 134) may display a feed of collaboration items that reflect comments/changes to the document. The user may select a displayed collaboration item from the newsfeed (e.g. select link “Spreadsheet’). In response to the selection, the spreadsheet may be opened (e.g. if the application is not already opened and/or the spreadsheet relating to the change/comment is not opened), and automatically navigated to the relevant portion of the document. A user may also respond to (e.g. comment on) a notification. For example, a response to a received notification may add the response to a comment stream within the document (e.g. response 134 from an SMS notification adds the response to comment stream 120′). More details and examples are provided below.

FIG. 2A shows exemplary notification mechanisms 200 used during collaboration on a document. As illustrated, FIG. 2A includes six different displays (210, 220, 230, 240, 250 and 260) that illustrate different notification mechanisms.

The displays may be shown on displays having a standard/large display (e.g. displays larger than 12 inches) as well as a device having a limited display size (e.g. a cell phone having a display of approximately 2 by 3 inches, a slate/tablet having approximately a 7-10 inch display, and/or other devices having other display sizes (e.g. 4, 5, 6, . . . ). The displays may also be shown on a touch screen.

Display 210 shows a display of a spreadsheet 210. In the current example, the user (Matthew) has just added object 212 to spreadsheet. In response to changing the content of the document and/or adding a comment to the document, the collaboration manager 26 (See FIG. 1) creates one or more different notifications to be delivered to the different collaborators based on the change. According to an embodiment, each user collaborating on the document, may select notification mechanisms on how he or she would like to be notified. An active endpoint for each user may also be determined before sending the notification. For example, one user may currently be on his or her tablet, another user on his or her desktop computer and another user may be currently offline. According to an embodiment, the user's configuration settings and the active endpoint of the user are used to determine what notification mechanisms to use. For example, a user may configure that when he or she is out of the office and on his or her mobile phone, he or she would like to be notified using SMS and/or MMS and social network. Another user may configure for email notifications, and the like.

Display 220 shows an exemplary SMS notification. In the current example, the user Matthew has added object 212 to spreadsheet 210. In response to the change, an SMS message is created and sent to users collaborating on the document that have indicated they would like to be notified using SMS. The SMS message may be created to include different content. For example, text alone, text with one or more links, and the like. According to an embodiment, the SMS message includes a link that when selected displays the document near the location of the change relating to the message. In the current example, if the user were to select link “Spreadsheet” within SMS message 222, spreadsheet 210 with a display of object 212 would be shown to the user. According to an embodiment, the link includes information relating to the location of the document, the application used to open the document as well as a location/region of the document to display when opened. A user receiving the message 222 may also reply to the message. For example, a user may use reply 224 to create a comment that is added to the document (e.g. spreadsheet 210). A new comment may be created when there are no related comments or the reply may be added as a comment to a comment stream that includes other related comments.

Display 230 shows an exemplary MMS notification. In the current example, the user Matthew has added object 212 to spreadsheet 210. In response to the change, an MMS message is created and sent to users collaborating on the document that have indicated they would like to be notified using MMS. The MMS message may be created to include different content. For example, text alone, text with one or more links, text and multimedia content, text, link and multimedia content and the like. According to an embodiment, the MMS message includes a link that when selected displays the document near the location of the change relating to the message and a representation (e.g. picture) of the relevant portion of the document near the change. In the current example, a picture of the newly added graphical object is added to the MMS message. The message also includes a link to the document (e.g. “Spreadsheet”) and relevant location within the document. A user receiving the message 232 may also reply to the message.

Display 240 shows an exemplary news notification. In the current example, the user Matthew has added object 212 to spreadsheet 210. In response to the change, news notification is created and added to a newsfeed relating to the collaboration. For example, a news feed may be created within the application (e.g. spreadsheet) and/or some other application may be used to display the newsfeed. According to an embodiment, each collaborator is allowed to view/interact with items in the newsfeed. Permissions may also be set to configure access/interaction with the items in the newsfeed. The newsfeed may be created to include different content. For example, text alone, text with one or more links, text and multimedia content, text, link and multimedia content and the like. According to an embodiment, the newsfeed includes a link that when selected displays the document near the location of the change relating to the message and a representation (e.g. picture) of the relevant portion of the document near the change. In the current example, the message includes a link to the document (e.g. “Spreadsheet”) and relevant location within the document. A user may also reply to the newsfeed.

Display 250 shows an exemplary electronic mail notification. In the current example, the user Matthew has added object 212 to spreadsheet 210. In response to the change, an email notification is created and sent to the users collaborating on the document that have requested email notification. The email may be created to include different content (e.g. text/pictures, link(s), HTML, and the like). In the current example, the email includes a link to the document (e.g. “Spreadsheet”) and a representation of the portion of the document near the change and/or object added to the document. A user may also reply to the email notification using reply button 252.

Display 260 shows an exemplary social network notification. In the current example, the user Matthew has added object 212 to spreadsheet 210. In response to the change, a social network notification is created (e.g. notification, message, . . . ) and posted to the social network. The posting may be created to include different content (e.g. text/pictures, link(s), HTML, and the like). In the current example, the social network notification includes a link to the document (e.g. “Spreadsheet”). A user may also reply/post to the social notification using a post/reply operation (not shown).

FIG. 2B shows exemplary documents that may be collaborated on. As illustrated, FIG. 2B includes four different displays (210, 270, 280 and 290) that illustrate different types of documents.

Display 210 shows a display of a spreadsheet 210. As discussed above, a user may make a change to the content of the document (e.g. add a comment/edit content of the document). In response to changing the content of the document, the collaboration manager 26 (See FIG. 1) creates one or more different notifications to be delivered to the different collaborators based on the change.

Display 270 shows a display of a slide within a presentation document 210. For example, a user may add pie chart 272 to presentation 270. In response to adding pie chart 272, one or more different notifications are created and delivered to the different collaborators based on the change.

Display 280 shows a display of word-processing document 210. In the current example, a user adds comment 282 to document 280. In response to adding comment 282, one or more different notifications are created and delivered to the different collaborators based on the change.

Display 290 shows a display of some type of other document (e.g. graphics document, note document, . . . . ). In the current example, user 2 adds comment 294 in response to the comment made by User 1. In response to adding comment 294, one or more different notifications are created and delivered to the different collaborators based on the change.

FIG. 3 shows exemplary notification mechanisms 300 used during collaboration on a document. As illustrated, FIG. 3 includes six different displays (310, 320, 330, 340, 350 and 360) which illustrate different notification mechanisms.

Display 310 shows a display of a spreadsheet 310. In the current example, the user (Avijit) has just added comment 312 to the spreadsheet. In response to adding comment 312 to spreadsheet 310, one or more different notification mechanisms are used to inform the different collaborators of the added comment.

Display 320 shows an exemplary SMS notification. In response to the comment, an SMS message is created and sent to users collaborating on the document that have indicated they would like to be notified using SMS. In the current example, SMS message 322 is created and sent that includes a link and at least a portion of the comment. According to an embodiment, the message identifies the collaborator making the change (e.g. Avijit), a link to the document identifying the relevant location of the comment/change, and the portion of the comment that fits within the message size allowed by the notification mechanism (e.g. up to 160 characters for SMS).

Display 330 shows an exemplary MMS notification. In the current example, the user Avijit has added comment 312 to spreadsheet 310. In response to the comment, an MMS message is created and sent to users collaborating on the document that have indicated they would like to be notified using MMS. In the current example, a picture of the relevant content to the comment, the link, and at least a portion of the comment are included in the MMS message.

Display 340 shows an exemplary news notification. In the current example, the user Avijit has added comment 312 to spreadsheet 310. In response to the comment, an news notification is created and added to the newsfeed. In the current example, the new notification identifies the collaborator making the change (e.g. Avijit), a link to the document identifying the relevant location of the comment/change, and the portion of the comment.

Display 350 shows an exemplary electronic mail notification. In the current example, an email message 354 is created and sent that includes a link and at least a portion of the comment. According to an embodiment, the message identifies the collaborator making the change (e.g. Avijit), a link to the document identifying the relevant location of the comment/change, and the comment. The email message may also include a representation of the document relevant to the comment/change.

Display 360 shows an exemplary social network notification. In the current example, the social network notification identifies the collaborator making the change (e.g. Avijit), a link to the document identifying the relevant location of the comment/change, and the comment. The social network notification may also include a representation of the document relevant to the comment/change.

FIG. 4 shows exemplary notifications 400 created in response to a user selecting a portion of a document and making a comment during collaboration on a document. As illustrated, FIG. 4 includes six different displays (410, 420, 430, 440, 450 and 460) that illustrate different notification mechanisms.

Display 410 shows a display of a spreadsheet 410. In the current example, the user (Olivier) has selected cells 412 and added comment 414 to the spreadsheet. In response to adding comment 414 to spreadsheet 410, one or more different notification mechanisms are used to inform the different collaborators of the comment.

Display 420 shows an exemplary SMS notification. In the current example, SMS message 422 is created and sent that includes a link, at least a portion of the comment, and an identification of the selected content (e.g. cells B1, B2 and B3).

Display 430 shows an exemplary MMS notification. In the current example, a picture of the selected content, the link, and at least a portion of the comment are included in the MMS message 432.

Display 440 shows an exemplary news notification. In the current example, the news notification 442 identifies the collaborator making the comment and selecting the content (e.g. Olivier), a link to the document identifying the relevant location of the comment/change/selection, a portion of the comment, and an identification of the selected content (e.g. cells B1, B2 and B3).

Display 450 shows an exemplary electronic mail notification. In the current example, the email message identifies the collaborator making the change (e.g. Olivier), a link to the document identifying the relevant location of the comment/change, and the comment. The email message may also include a representation of the document selected.

Display 460 shows an exemplary social network notification. In the current example, the social network notification identifies the collaborator making the change (e.g. Olivier), a link to the document identifying the relevant location of the comment/change, and the comment. The social network notification may also include a representation of the document relevant to the comment/change and/or an identification of the selected content.

FIG. 5 shows exemplary notifications 500 created in response to a user selecting a portion of a document and making a comment during collaboration on a document. As illustrated, FIG. 5 includes six different displays (510, 520, 530, 540, 550 and 560) that illustrate different notification mechanisms.

Display 510 shows a display of a spreadsheet 510. In the current example, the user (Steven) has added a multimedia comment (e.g. audio, video, audio/video, picture) 512 to the spreadsheet. In response to adding multimedia comment 512 to spreadsheet 510, one or more different notification mechanisms are used to inform the different collaborators of the comment.

Display 520 shows an exemplary SMS notification. In the current example, SMS message 522 is created and sent that includes a link to the document and a link to play the media content.

Display 530 shows an exemplary MMS notification. In the current example, a link to the document and a link to play the media content are included in the MMS message 532.

Display 540 shows an exemplary news notification. In the current example, the new notification 542 identifies the collaborator making the comment (e.g. Steven), a link to the document identifying the relevant location of the comment/change/selection and a link to play the media comment.

Display 550 shows an exemplary electronic mail notification. In the current example, the email message identifies the collaborator making the change (e.g. Steven), a link to the document identifying the relevant location of the comment/change, a link 554 and/or the media file 556 to play the comment.

Display 560 shows an exemplary social network notification. In the current example, the social network notification 562 identifies the collaborator making the change (e.g. Steven), a link to the document identifying the relevant location of the comment/change, and a link to play the media comment. The social network notification may also include a representation of the document relevant to the comment/change and/or an identification of the selected content.

FIG. 6 shows an illustrative process for notifying users of changes made to a document during collaboration. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process moves to operation 610, where content is displayed. The content displayed may be different types of contents. For example, the content may be a spreadsheet, a document, a presentation, images, files, and the like. According to an embodiment, the content is a spreadsheet document that may include one or more sheets in a workbook.

Moving to operation 620, a determination is made as to when a change is made to a document that is being collaborated on. The change may relate to a content change (e.g. adding/deleting/moving/changing content) and/or adding a comment. The comment may be a new comment that is unrelated to other comments or a related comment that is included within a comment stream (e.g. related comments from one or more users. Different methods may be used to make a change/comment to a document. For example, a UI element may be selected, a user may say a command, a user may perform a gesture, and the like.

Flowing to operation 630, a portion of the document affected by the change is determined. The portion affected by the change may be automatically/manually determined. For example, a user may manually select a portion of the document (e.g. one or more cells/words/paragraphs/objects/ . . . ) to indicate the relevant portion of the document. More than one portion of the document may be affected. For example, the change may affect data in one or more portions of the document (e.g. on a same/different sheet of a workbook, a different pages of a document, . . . ). The portion affected by the change may also be automatically identified by the application (e.g. a spreadsheet application). For example, when a comment is entered, the portion of the document near the comment (e.g. cell/object) is automatically identified as the affected portion. When content is added/deleted/changed/moved the portion of the document near the change is identified.

Transitioning to operation 640, notification method(s) used in delivering notifications to collaborators are determined. The different notification mechanisms used to notify users may include mechanisms such as: Short Message Service (SMS), Multimedia Messaging Service (MMS), electronic mail, Instant Messaging (IM), social network post/message, Mobile Phone Notification Queue, and the like. A user may configure the desired notification methods. An active endpoint for each user may also be determined before sending the notification to determine the notification method. For example, one user may currently be on his or her tablet, another user on his or her desktop computer and another user may be currently offline. According to an embodiment, the user's configuration settings and the active endpoint of the user are used to determine what notification mechanisms to use. For example, a user may configure that when he or she is out of the office and on his or her mobile phone, he or she would like to be notified using SMS and/or MMS and social network. Another user may configure for email notifications, and the like.

Moving to operation 650, the notification is created for the different notification mechanisms determined. The notifications includes a link that when selected displays the document near the location of the change/comment. According to an embodiment, the link includes information relating to the location of the document, the application used to open the document as well as a location/region of the document to display when opened. Different notifications may be created for the different notification mechanisms. For example, some notifications may include rich content (e.g. pictures/video/sound), while other notifications consist of text.

Flowing to operation 660, the notifications are delivered using the different notification methods. For example, a SMS message may be sent using an SMS service, a MMS message may be sent using an MMS service, an IM message may be sent using an IM service, an email message may be sent using an email service, a message may be added to a newsfeed using an application/service, a toast notification (e.g. a small informational window), a live tile notification, and the like.

Moving to operation 670, a received response may be incorporated into the document. For example, a comment may be placed into the document being collaborated on based on the content within the response. According to an embodiment, the location to place the comment in the document is based on the location included within the link in the original message. For example, the link may indicate a location within the document and/or a comment location for the comment. When the response is a comment related to another comment, the response is added as a comment to a comment stream. When the response is a comment that is not to another comment, the response is added at/near the location indicated by the link.

The process then flows to an end operation and returns to processing other actions.

FIG. 7 illustrates an exemplary system for collaborating on a document using different notification mechanisms. As illustrated, system 1000 includes service 1010, data store 1045, notification mechanisms 1046, and touch screen device 1050 (e.g. a slate), smart phone 1030, and display device 1080 (e.g. monitor/television, . . . ).

Each device (e.g. device 1050, smart phone 1030, display device 1080) may be configured to receive input from one or more sensing devices. The sensing device may be a part of the device and/or separate from the device. The sensing device may be configured to capture user input using various input methods. A sensing device may include one or more microphones to capture spoken input (e.g. words) and one or more cameras to detect movement of a user (e.g. pictures/videos). The sensing device may also be configured to capture other inputs from a user such as by a keyboard and/or mouse (not pictured). For example, the sensing device may be a MICROSOFT KINECT® device comprising a plurality of cameras and a plurality of microphones

As illustrated, service 1010 is a cloud based and/or enterprise based service that may be configured to provide spreadsheet services. Service 1010 may provide other services and/or additional services. The service may be configured to be interacted with using different types of input/output. For example, a user may use speech input, touch input, hardware based input, and the like. The service may provide speech output and/or sound effects. Functionality of one or more of the services/applications provided by service 1010 may also be configured as a client/server based application.

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen device 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030, touch screen device 1050 and display device 1080 are configured with multimodal applications (1031, 1051, 1081). While the application is illustrated as part of the device, the application may be a network application (e.g. included as part of service 1010) that is stored externally from the device.

As illustrated, touch screen device 1050, smart phone 1030 and device 1080 shows exemplary displays 1052/1032/1082 showing the use of an application that utilize multimodal input/output (e.g. speech/graphical displays/gestures (touch/non-touch)). Data may be stored on a device (e.g. smart phone 1030, device 1050 and/or at some other location (e.g. network data store 1045). Data store 1054 may be used to store spreadsheet data used by the service. The applications used by the devices may be client based applications, server based applications, cloud based applications and/or some combination.

Collaboration manager 26 is configured to perform operations relating to collaborating on a document and using different notification mechanisms as described herein. While manager 26 is shown within service 1010, the all/part of the functionality of the manager may be included in other locations (e.g. on smart phone 1030, device 1050 and/or display device 1080).

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 8, 9 and 10 and the associated descriptions provide a discussion of a variety of operating environments in which embodiments of the invention may be practiced. However, the devices and systems illustrated and discussed with respect to FIGS. 8, 9 and 10 are for purposes of example and illustration and are not limiting of a vast number of computing device configurations that may be utilized for practicing embodiments of the invention, described herein.

FIG. 8 is a block diagram illustrating example physical components of a computing device 1100 with which embodiments of the invention may be practiced. The computing device components described below may be suitable for the computing devices described above. In a basic configuration, computing device 1100 may include at least one processing unit 1102 and a system memory 1104. Depending on the configuration and type of computing device, system memory 1104 may comprise, but is not limited to, volatile (e.g. random access memory (RAM)), non-volatile (e.g. read-only memory (ROM)), flash memory, or any combination. System memory 1104 may include operating system 1105, one or more programming modules 1106, and may include a web browser application 1120. Operating system 1105, for example, may be suitable for controlling computing device 1100's operation. In one embodiment, programming modules 1106 may include a collaboration manager 26, as described above, installed on computing device 1100. Furthermore, embodiments of the invention may be practiced in conjunction with a graphics library, other operating systems, or any other application program and is not limited to any particular application or system. This basic configuration is illustrated in FIG. 8 by those components within a dashed line 1108.

Computing device 1100 may have additional features or functionality. For example, computing device 1100 may also include additional data storage devices (removable and/or non-removable) such as, for example, magnetic disks, optical disks, or tape. Such additional storage is illustrated by a removable storage 1109 and a non-removable storage 1110.

As stated above, a number of program modules and data files may be stored in system memory 1104, including operating system 1105. While executing on processing unit 1102, programming modules 1106, such as the manager may perform processes including, for example, operations related to methods as described above. The aforementioned process is an example, and processing unit 1102 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the manager 26 may be operated via application-specific logic integrated with other components of the computing device/system 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 1104, removable storage 1109, and non-removable storage 1110 are all computer storage media examples (i.e., memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1100. Any such computer storage media may be part of device 1100. Computing device 1100 may also have input device(s) 1112 such as a keyboard, a mouse, a pen, a sound input device, a touch input device, etc. Output device(s) 1114 such as a display, speakers, a printer, etc. may also be included. The aforementioned devices are examples and others may be used.

A camera and/or some other sensing device may be operative to record one or more users and capture motions and/or gestures made by users of a computing device. A sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIGS. 9A and 9B illustrate a suitable mobile computing environment, for example, a mobile telephone, a smartphone, a tablet personal computer, a laptop computer, and the like, with which embodiments of the invention may be practiced. With reference to FIG. 9A, an example mobile computing device 1200 for implementing the embodiments is illustrated. In a basic configuration, mobile computing device 1200 is a handheld computer having both input elements and output elements. Input elements may include touch screen display 1205 and input buttons 1210 that allow the user to enter information into mobile computing device 1200. Mobile computing device 1200 may also incorporate an optional side input element 1215 allowing further user input. Optional side input element 1215 may be a rotary switch, a button, or any other type of manual input element. In alternative embodiments, mobile computing device 1200 may incorporate more or less input elements. For example, display 1205 may not be a touch screen in some embodiments. In yet another alternative embodiment, the mobile computing device is a portable phone system, such as a cellular phone having display 1205 and input buttons 1210. Mobile computing device 1200 may also include an optional keypad 1235. Optional keypad 1235 may be a physical keypad or a “soft” keypad generated on the touch screen display.

Mobile computing device 1200 incorporates output elements, such as display 1205, which can display a graphical user interface (GUI). Other output elements include speaker 1225 and LED 1220. Additionally, mobile computing device 1200 may incorporate a vibration module (not shown), which causes mobile computing device 1200 to vibrate to notify the user of an event. In yet another embodiment, mobile computing device 1200 may incorporate a headphone jack (not shown) for providing another means of providing output signals.

Although described herein in combination with mobile computing device 1200, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 9B is a block diagram illustrating components of a mobile computing device used in one embodiment, such as the computing device shown in FIG. 9A. That is, mobile computing device 1200 can incorporate system 1202 to implement some embodiments. For example, system 1202 can be used in implementing a “smart phone” that can run one or more applications similar to those of a desktop or notebook computer such as, for example, spreadsheet applications, presentation applications, browser, e-mail, scheduling, instant messaging, and media player applications. In some embodiments, system 1202 is integrated as a computing device, such as an integrated personal digital assistant (PDA) and wireless phoneme.

One or more application 1266 may be loaded into memory 1262 and run on or in association with operating system 1264. Examples of application programs include phone dialer programs, e-mail programs, PIM (personal information management) programs, word processing programs, spreadsheet programs, presentation/slideshow programs, Internet browser programs, messaging programs, and so forth. System 1202 also includes non-volatile storage 1268 within memory 1262. Non-volatile storage 1268 may be used to store persistent information that should not be lost if system 1202 is powered down. Applications 1266 may use and store information in non-volatile storage 1268, such as spreadsheet content, document content, e-mail or other messages used by an e-mail application, and the like. A synchronization application (not shown) may also reside on system 1202 and is programmed to interact with a corresponding synchronization application resident on a host computer to keep the information stored in non-volatile storage 1268 synchronized with corresponding information stored at the host computer. As should be appreciated, other applications may be loaded into memory 1262 and run on the device 1200, including the collaboration manager 26, described above.

System 1202 has a power supply 1270, which may be implemented as one or more batteries. Power supply 1270 might further include an external power source, such as an AC adapter or a powered docking cradle that supplements or recharges the batteries.

System 1202 may also include a radio 1272 that performs the function of transmitting and receiving radio frequency communications. Radio 1272 facilitates wireless connectivity between system 1202 and the “outside world,” via a communications carrier or service provider. Transmissions to and from radio 1272 are conducted under control of OS 1264. In other words, communications received by radio 1272 may be disseminated to application 1266 via OS 1264, and vice versa.

Radio 1272 allows system 1202 to communicate with other computing devices, such as over a network. Radio 1272 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 1202 is shown with two types of notification output devices; LED 1220 that can be used to provide visual notifications and an audio interface 1274 that can be used with speaker 1225 to provide audio notifications. These devices may be directly coupled to power supply 1270 so that when activated, they remain on for a duration dictated by the notification mechanism even though processor 1260 and other components might shut down for conserving battery power. LED 1220 may be programmed to remain on indefinitely until the user takes action to indicate the powered-on status of the device. Audio interface 1274 is used to provide audible signals to and receive audible signals from the user. For example, in addition to being coupled to speaker 1225, audio interface 1274 may also be coupled to a microphone to receive audible input, such as to facilitate a telephone conversation. In accordance with embodiments of the present invention, the microphone may also serve as an audio sensor to facilitate control of notifications, as will be described below. System 1202 may further include video interface 1276 that enables an operation of on-board camera 1230 to record still images, video stream, and the like.

A mobile computing device implementing system 1202 may have additional features or functionality. For example, the device may also include additional data storage devices (removable and/or non-removable) such as, magnetic disks, optical disks, or tape. Such additional storage is illustrated in FIG. 8B by storage 1268. Computer storage media may include volatile and nonvolatile, removable and non-removable media implemented in any method or technology for storage of information, such as computer readable instructions, data structures, program modules, or other data.

Data/information generated or captured by the device 1200 and stored via the system 1202 may be stored locally on the device 1200, as described above, or the data may be stored on any number of storage media that may be accessed by the device via the radio 1272 or via a wired connection between the device 1200 and a separate computing device associated with the device 1200, for example, a server computer in a distributed computing network such as the Internet. As should be appreciated such data/information may be accessed via the device 1200 via the radio 1272 or via a distributed computing network. Similarly, such data/information may be readily transferred between computing devices for storage and use according to well-known data/information transfer and storage means, including electronic mail and collaborative data/information sharing systems.

FIG. 10 illustrates a system architecture for a system as described herein.

Components managed via the collaboration manager 26 may be stored in different communication channels or other storage types. For example, components along with information from which they are developed may be stored using directory services 1322, web portals 1324, mailbox services 1326, instant messaging stores 1328 and social networking sites 1330. The systems/applications 26, 1320 may use any of these types of systems or the like for enabling management and storage of components in a store 1316. A server 1332 may provide communications and services relating to the collaboration and notification as described herein. Server 1332 may provide services and content over the web to clients through a network 1308. Examples of clients that may utilize server 1332 include computing device 1302, which may include any general purpose personal computer, a tablet computing device 1304 and/or mobile computing device 1306 which may include smart phones. Any of these devices may obtain display component management communications and content from the store 1316.

Embodiments of the present invention are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for collaboration, comprising:
determining when a change is made to a spreadsheet, including determining when content of the spreadsheet is changed and determining when a comment is added to the spreadsheet;
determining a notification mechanism used to notify a collaborator of the change;
creating a notification including a link indicating a portion of the spreadsheet where the change was made; and
using the notification method to deliver the notification.

2. The method of claim 1, further comprising adding the comment to the comment stream when the comment it is determined that the comment is made in relation to another comment.

3. The method of claim 1, wherein the notification mechanism comprises at least one of: a Short Message Service (SMS), a Multimedia Messaging Service (MMS), an electronic mail program, an Instant Messaging (IM) program, a social network; a newsfeed, a toast notification mechanism; and a live tile notification mechanism.

4. The method of claim 1, further comprising in response to receiving a selection of the link: launching the spreadsheet application and displaying the portion of the spreadsheet related to the change.

5. The method of claim 1, determining when a reply is made to the notification and automatically incorporating the reply in the spreadsheet.

6. The method of claim 1, further comprising adding an audio file to the spreadsheet when it is determined that the comment added to the spreadsheet is an audio comment and adding a multimedia file comprising audio content and video content when it is determined that the comment added to the spreadsheet is a multimedia comment.

7. The method of claim 1, further comprising determining an active endpoint associated with the collaborator and determining the notification mechanism based on the active endpoint.

8. The method of claim 1, wherein creating the notification comprises including at least a portion of the change within the notification.

9. The method of claim 1, wherein determining the notification mechanism used to notify the collaborator of the change comprises accessing a configuration specifying one or more notification mechanisms.

10. A computer-readable medium storing computer-executable instructions for collaboration, comprising:
determining when a change is made to a document, including determining when content of the document is changed and determining when a comment is added to the document;
determining a notification mechanism used to notify a collaborator of the change;
creating a notification including a link indicating a portion of the document where the change was made;
using the notification method to deliver the notification; and
automatically incorporating a reply to the notification in the document as a comment.

11. The computer-readable medium of claim 10, further comprising adding the comment to the comment stream when the comment it is determined that the comment is made in relation to another comment.

12. The computer-readable medium of claim 10, wherein the notification mechanism comprises at least one of: a Short Message Service (SMS), a Multimedia Messaging Service (MMS), an electronic mail program, an Instant Messaging (IM) program, a social network; a Mobile Phone Notification Queue; a newsfeed; a toast notification mechanism; and a live tile notification mechanism.

13. The computer-readable medium of claim 10, further comprising in response to receiving a selection of the link: launching the application associated with the document and displaying the portion of the document related to the change.

14. The computer-readable medium of claim 10, further comprising adding an audio file to the document when it is determined that the comment added to the document is an audio comment and adding a multimedia file comprising audio content and video content when it is determined that the comment added to the document is a multimedia comment.

15. The computer-readable medium of claim 10, further comprising determining an active endpoint associated with the collaborator and determining the notification mechanism based on the active endpoint.

16. The computer-readable medium of claim 10, wherein creating the notification comprises including at least a portion of the change within the notification.

17. A system for collaboration, comprising:
a display that is configured to receive touch input;
a processor and memory;
an operating environment executing using the processor;
a display; and
a collaboration manager that is configured to perform actions comprising:
determining when a change is made to a document, including determining when content of the document is changed and determining when a comment is added to the document;
determining a notification mechanism used to notify a collaborator of the change, wherein the notification method comprises at least one of: a Short Message Service (SMS), a Multimedia Messaging Service (MMS), an electronic mail program, an Instant Messaging (IM) program, a social network; a Mobile Phone Notification Queue and a newsfeed;
creating a notification including a link indicating a portion of the document where the change was made;
using the notification method to deliver the notification; and
automatically incorporating a reply to the notification in the document as a comment.

18. The system of claim 17, further comprising adding the comment to the comment stream in the document that is a spreadsheet when the comment it is determined that the comment is made in relation to another comment.

19. The system of claim 17, further comprising in response to receiving a selection of the link: launching the application associated with the document and displaying the portion of the document related to the change.

20. The system of claim 17, further comprising adding an audio file to the document when it is determined that the comment added to the document is an audio comment and adding a multimedia file comprising audio content and video content when it is determined that the comment added to the document is a multimedia comment.
